(19) United States
(12) Patent Application Publication
(10) Pub. No.: US 2026/0220782 A1
(43) Pub. Date: Jul. 30, 2026

(54) METHOD AND COMPUTER SYSTEM FOR ANALYZING GASTRIC ENDOSCOPIC IMAGE UTILIZING IMAGE SEGMENTATION TECHNOLOGY

(71) Applicants: Hsiu-Chi CHENG, Tainan City (TW); Ton-Yen General Hospital, Hsinchu County (TW)

(72) Inventors: Hsiu-Chi CHENG, Tainan City (TW); Chun-Rong HUANG, Tainan City (TW); Hsiao-Bai YANG, Hsinchu County (TW); Wei-Lun CHANG, Tainan City (TW); Er-Hsiang YANG, Tainan City (TW); Po-Hsiang HSU, Tainan City (TW)

(21) Appl. No.: 18/871,210

(22) PCT Filed: Jul. 1, 2024
(86) PCT No.: PCT/CN2024/102836

§ 371 Date: Dec. 3, 2024

(51) Int. Cl. G06T 7/11; G06T 7/00

(52) U.S. Cl. CPC G06T 7/11; G06T 7/0012; G06T 2207/10068; G06T 2207/20021; G06T 2207/20081; G06T 2207/20084; G06T 2207/30092

(57) ABSTRACT

The present disclosure relates to a method for analyzing a gastric endoscopy image by utilizing image segmentation technology. The method includes: cutting the gastric endoscopy image into a plurality of patches; inputting the patches into an encoder to obtain an encoded feature map; inputting the encoded feature map into a decoder to obtain a decoded feature map; and inputting the decoded feature map into a mask focal modulation decoder. The mask focal modulation decoder inputs a first prototype feature into a focal modulation function to obtain a focal modulation feature, inputs the decoded feature map into a scaling function then into a projection function to obtain a scaled feature, and generates a second prototype feature based on a mask, the scaled feature, and the focal modulation feature. A prediction mask is generated based on the second prototype feature for segmenting a gastric intestinal metaplasia area.

### BACKGROUND

### Technical Field

The present disclosure relates to a method for analyzing a gastric endoscopic image by utilizing deep learning technology, in particular to segment gastric intestinal metaplasia area in the gastric endoscopic image.

### Description of Related Art

Gastric cancer is the sixth most common cancer in the world and the fourth leading cause of cancer death. Gastric cancer occurs after Helicobacter pylori infection through inflammation of the gastric body, gastric atrophy, and gastric intestinal metaplasia. Since early diagnosis may improve disease survival rates, to regular follow-up of patients who have already suffered from precancerous lesions, such as gastric intestinal metaplasia, is very important. How to correctly diagnose and grade gastric body inflammation and gastric intestinal metaplasia during gastroscopy is an important clinical issue. Currently, diagnosis of gastric body inflammation and gastric intestinal metaplasia requires biopsies from five to six locations in the stomach during gastroscopy, which are then interpreted by a pathologist. The advantage is that it may be correctly diagnosed through pathological interpretation, but the disadvantage is time-consuming, creating risks such as bleeding, and not suitable for large-scale screening. Therefore, developing a technology that does not require invasive biopsy and can quickly analyze gastric intestinal metaplasia is an important issue in precision health that still needs to be developed.

### SUMMARY

One aspect of the present disclosure relates to an analyzing method for gastric endoscopic image utilizing image segmentation technology, the analyzing method adapted to a computer system, and includes obtaining a gastric endoscopic image and cutting the gastric endoscopic image into a plurality of patches; inputting one of the patches into an encoder to obtain an encoded feature map; inputting the encoded feature map into a decoder to obtain a decoded feature map; inputting the decoded feature map into a mask focal modulation decoder, in which the mask focal modulation decoder includes a plurality of mask focal modulation stages, and in which one of the mask focal modulation stages is utilized to receive the decoded feature map and a first prototype feature, inputting the first prototype feature into a focal modulation function to obtain a focal modulation feature, inputting the decoded feature map into a scaling function then into a projection function to obtain a scaled feature and generating a second prototype feature based on a mask, the scaled feature, and the focal modulation feature; and generating a prediction mask based on the second prototype feature, in which the prediction mask includes a plurality of pixels for segmenting a gastric intestinal metaplasia area.

In accordance with one or more embodiments of the present disclosure, generating a prediction mask based on the second prototype feature further includes inputting the second prototype feature corresponding to a last stage among the mask focal modulation stages into a plurality of neural networks to obtain a mask feature and a category feature; performing element-wise multiplication on the mask feature and the decoded feature map to obtain a binarization mask; and performing element-wise multiplication on the binarization mask and the category feature to obtain the prediction mask.

In accordance with one or more embodiments of the present disclosure, generating the second prototype feature based on the mask, the scaled feature, and the focal modulation feature includes performing element-wise multiplication on the mask, the scaled feature, and the focal modulation feature to obtain the second prototype feature.

In accordance with one or more embodiments of the present disclosure, in which the mask includes a plurality of values, and the analyzing method further includes determining whether each of the values of the mask is less than a threshold to generate a next stage mask.

In accordance with one or more embodiments of the present disclosure, the decoder includes a plurality of focal modulation blocks, and the decoder is a pixel decoder.

Another aspect of the present disclosure relates to a computer system, which includes a memory and a processor. The memory is configured to store a plurality of instructions. The processor is coupled to the memory, and configured to execute the instructions to perform the following steps: obtaining a gastric endoscopic image and cutting the gastric endoscopic image into a plurality of patches; inputting one of the patches into an encoder to obtain an encoded feature map; inputting the encoded feature map into a decoder to obtain a decoded feature map; inputting the decoded feature map into a mask focal modulation decoder, in which the mask focal modulation decoder including a plurality of mask focal modulation stages, one of the mask focal modulation stages is utilized to receive the decoded feature map and a first prototype feature, inputting the first prototype feature into a focal modulation function to obtain a focal modulation feature, inputting the decoded feature map into a scaling function then into a projection function to obtain a scaled feature and generating a second prototype feature based on a mask, the scaled feature, and the focal modulation feature; and generating a prediction mask based on the second prototype feature, in which the prediction mask includes a plurality of pixels for segmenting a gastric intestinal metaplasia area.

In accordance with one or more embodiments of the present disclosure, generating a prediction mask based on the second prototype feature further includes inputting the second prototype feature corresponding to a last stage among the mask focal modulation stages into a plurality of neural networks to obtain a mask feature and a category feature; performing element-wise multiplication on the mask feature and the decoded feature map to obtain a binarization mask; and performing element-wise multiplication on the binarization mask and the category feature to obtain the prediction mask.

In accordance with one or more embodiments of the present disclosure, generating the second prototype feature based on the mask, the scaled feature, and the focal modulation feature includes performing element-wise multiplication on the mask, the scaled feature, and the focal modulation feature to obtain the second prototype feature.

In accordance with one or more embodiments of the present disclosure, the mask includes a plurality of values, and the processor is further configured to determine whether each of the values of the mask is less than a threshold to generate a next stage mask.

In accordance with one or more embodiments of the present disclosure, the decoder includes a plurality of focal modulation blocks, and the decoder is a pixel decoder.

### BRIEF DESCRIPTION OF THE DRAWINGS

This disclosure can be more fully understood by reading the following detailed description of the embodiments, with reference made to the accompanying drawings as follows:

FIG. 1 is a schematic diagram of a computer system in accordance with some embodiments of the present disclosure.

FIG. 2 is a schematic diagram for illustrating a deep learning network in accordance with some embodiments of the present disclosure.

FIG. 3 is a schematic diagram of the structure of a mask focal modulation block in accordance with some embodiments of the present disclosure.

FIG. 4 is a schematic diagram for illustrating a mask focal modulation layer in accordance with some embodiments of the present disclosure.

FIG. 5 is a schematic diagram of experimental results in accordance with some embodiments of the present disclosure.

FIG. 6 is a flowchart of a method for analyzing a gastric endoscopic image utilizing image segmentation technology in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are utilized in the drawings and the description to refer to the same or like parts.

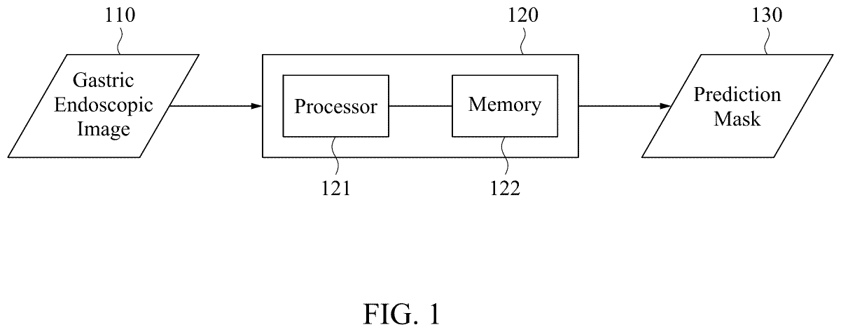

FIG. 1 is a schematic diagram of a computer system 120 in accordance with some embodiments of the present disclosure. Referring to FIG. 1, the computer system 120 includes a processor 121 and a memory 122 for processing a gastric endoscopic image 110 to generate a prediction mask 130. The prediction mask 130 is utilized to segment the location of gastric intestinal metaplasia. From another perspective, the prediction mask 130 may also be called a segmentation result of the gastric endoscopic image 110, and the segmentation result is to segment a gastric intestinal metaplasia area. It should be noted that the gastric endoscopic image 110 may be a gastric endoscopic image of a gastric antrum, a gastric body, or a gastric cardia. The position, the resolution, and the angle of the gastric endoscopic image 110 are not limited in this disclosure.

The computer system 120 may be a personal computer, a server, a medical-related equipment, or various electronic devices with computing capabilities, but is not limited thereto. The processor 121 may be a central processing unit (CPU), a graphics processing unit (GPU), a microcontroller unit (MCU), a microprocessor, a tensor processing unit, or an application-specific integrated circuit, but is not limited to thereto. The memory 122 may be a random access memory (RAM), a read-only memory (ROM), a flash memory, a floppy disk, a hard disk, an optical disk, a flash drive, a tape, or a database accessible from the network. The memory 122 is utilized to store a plurality of instructions, and the processor 121 executes these instructions to complete the method for analyzing the gastric endoscopic image 110. The method is described below.

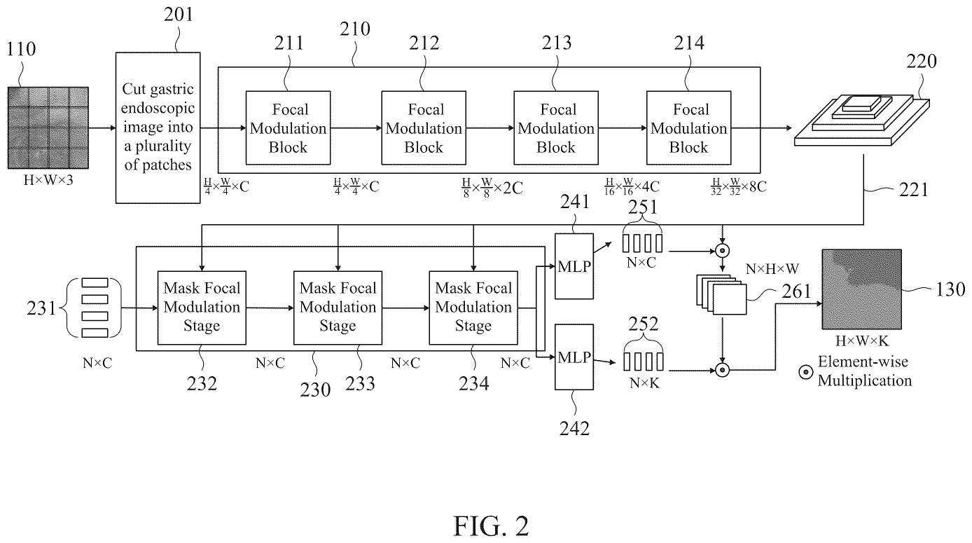

In the disclosure, the prediction mask 130 is generated by utilizing a deep learning network. FIG. 2 is a schematic diagram for illustrating a deep learning network in accordance with some embodiments of the present disclosure. Referring to FIG. 2, first, in step 201, the gastric endoscopic image 110 is cut into a plurality of patches. For example, the resolution of the gastric endoscopic image 110 is H×W×3, and patches are cut on both the horizontal and vertical axes. After cutting, the size of each patch is

$$\frac{H}{4} \times \frac{W}{4} \times 3 ,$$

and then a trainable linear layer (such as a fully-connected layer) may be utilized to convert the patch into feature map of size

$$\frac{H}{4} \times \frac{W}{4} \times C$$

as input. The above H, W, and C are positive integers, such as H=224, H=224, and C=96, but the present disclosure is not limited to these numerical values.

The feature map converted from the patch is input to an encoder 210. This encoder 210 is, for example, a focal modulation network, including a plurality of focal modulation stages 211-214. For details, please refer to the first thesis “YANG, Jianwei, et al. Focal modulation networks. Advances in Neural Information Processing Systems, 2022, 35:4203-4217.” In this embodiment, the focal modulation stage 211 includes two focal modulation blocks, and the size of the feature map output by the focal modulation stage 211 is

$$\frac{H}{4} \times \frac{W}{4} \times C .$$

The focal modulation stage 212 includes two focal modulation blocks, and the size of the feature map output by the focal modulation stage 212 is

$$\frac{H}{8} \times \frac{W}{8} \times 2 C .$$

The focal modulation stage 213 includes six focal modulation blocks, and the size of the feature map output by the focal modulation stage 213 is

$$\frac{H}{16} \times \frac{W}{16} \times 4 C .$$

The size of the feature map output by the focal modulation stage 214 is

$$\frac{H}{32} \times \frac{W}{32} \times 8 C .$$

The feature map output by the encoder 210 is also called an encoded feature map. Through focal modulation, the entire network may learn visual features from a small field of view to a large field of view.

Next, the encoded feature map is input to a decoder 220. The decoder 220 includes a plurality of stages with different resolutions for generating a decoded feature map. The decoder 220 is, for example, a pixel decoder. For details, please refer to the second thesis “CHENG, Bowen, et al. Masked-attention mask transformer for universal image segmentation. In: Proceedings of the IEEE/CVF conference on computer vision and pattern recognition. 2022. p. 1290-1299,” which is not discussed in detail herein. The feature map generated by the decoder 220 is called a decoded feature map 221, which also represents as fₛ below, where s represents the stage of the pixel decoder, and the output resolution of the last stage is equal to one quarter of the original resolution, that is, the output resolution of the last stage is

$$\frac{H}{4} \times \frac{W}{4} .$$

Next, the decoded feature map fₛ is input to a mask focal modulation decoder 230. The mask focal modulation decoder 230 includes a plurality of mask focal modulation stages 232-234, and each of the mask focal modulation stages 232-234 receives the decoded feature map fₛ and includes three mask focal modulation blocks. In addition, the mask focal modulation stage 232 also accepts a trainable prototype feature 231, and the size of the trainable prototype feature 231 is N×C, where N is a positive integer (for example, 256), which is expressed as pp below, where b represents which mask focal modulation block. In each mask focal modulation stage 232, 233, or 234, the prototype feature p_{b} and the decoded feature map fₛ in the b^{th} mask focal modulation block are utilized to generate the prototype feature p_{b+1} in the (b+1)^{th} mask focal modulation block.

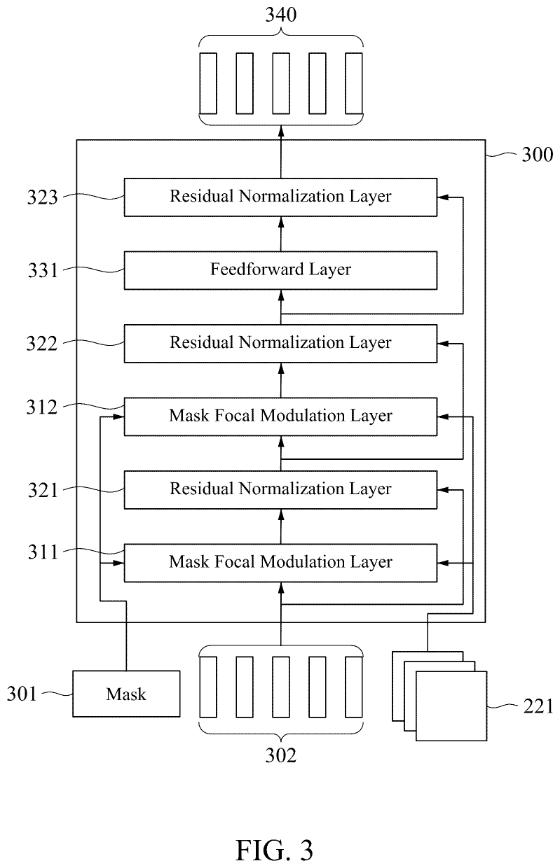

FIG. 3 is a schematic diagram of the structure of a mask focal modulation block in accordance with some embodiments of the present disclosure. Referring to FIG. 3, the mask focal modulation block 300 includes mask focal modulation layers 311-312, residual normalization layers 321-323 and a feedforward layer 331. A mask 301 is input to the mask focal modulation layers 311-312. A prototype feature 302 is input to the mask focal modulation layer 311 and the residual normalization layer 321. A decoded feature map 221 is input to the mask focal modulation layers 311-312. Each of the residual normalization layers 321-323 includes residual connection and layer normalization. The mask focal modulation block 300 generates a prototype feature 340 for the next mask focal modulation block. The mask 301 provides segmentation results, which are utilized to guide the model to focus on specific areas during the training process, while mask focal modulation provides semantic texture features at different sizes.

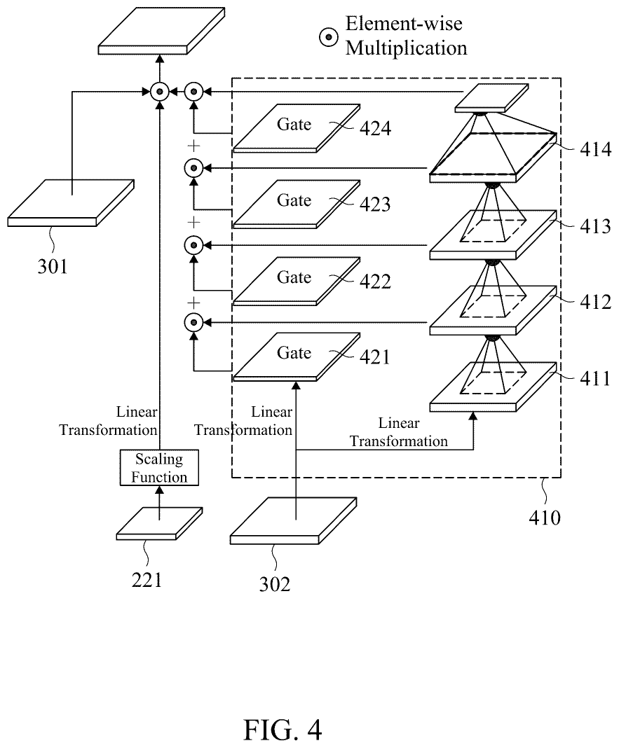

The operation of the mask focal modulation layers 311-312 is illustrated here. FIG. 4 is a schematic diagram for illustrating a mask focal modulation layer in accordance with some embodiments of the present disclosure. Referring to FIG. 4, the operation of the mask focal modulation layer may be expressed as Formula 1:

$$MFM ( {p}_{b} , {f}_{s} , {m}_{b} ) = Z ( {p}_{b} ) ⊙ F ( R ( {f}_{s} ) ) ⊙ {m}_{b} , \qquad [ Formula 1 ]$$

where MFM( ) represents the overall operation of the mask focal modulation layer, Z( ) is a focal modulation function, which is represented as the focal modulation function 410 in FIG. 4, Z(p_{b}) is also called a focal modulation feature, R( ) is a scaling function, F( ) is a projection function, which may be implemented by linear transformation, for example, and m_{b} is the mask 301 in the b^{th} mask focal modulation block. The prototype feature 302 in FIG. 4 is p_{b} in Formula 1, and the decoded feature map 221 is fₛ in Formula 1. In addition, the operator ⊙ is element-wise multiplication.

The prototype feature 302 is linearly transformed (for example, implemented through a fully-connected layer) and then provided to a plurality of convolutional layers 411-414 and a plurality of gates 421-424. Regarding the focal modulation function 410, reference may be made to the above-mentioned first thesis and may not be described in detail here. Similarly, the decoded feature map 221 undergoes a scaling function, and then undergoes a linear transformation (i.e., a projection function), thereby obtaining the scaled feature F(R(fₛ)).

The mask m_{b} is a binary mask. In the b^{th} mask focal modulation block, the mask m_{b} is generated from the (b−1)^{th} mask focal modulation block. Specifically, the upper-stage mask includes a plurality of values. These values are expressed as M_{b-1}(x, y), where x and y are coordinates. Next, it is determined whether each of these values is less than a threshold (for example, 0.5) to generate the mask m_{b} in the next stage, as shown in Formula 2:

$${m}_{b} ( x , y ) = \{ \begin{matrix}1 , if {M}_{b - 1} ( x , y ) < 0.5 \\ 0 , otherwise\end{matrix} . \qquad [ Formula 2 ]$$

Masking may force the model to focus on pixels that are difficult to classify. From another perspective, Formula 1 is to input the prototype feature p_{b} to a focal modulation function Z( ) to obtain the focal modulation feature Z(p_{b}), and input the decoded feature map fₛ to the scaling function R( ) and then substitute the projection function F( ) to obtain the scaling feature F(R(fₛ)), and then multiply the mask m_{b}, the scaling feature F(R(fₛ)) and the focal modulation feature Z(p_{b}) to generate the prototype feature MFM(p_{b}, fₛ, m_{b}) which may be used in the subsequent networks.

Referring to FIG. 2, after passing through the mask focal modulation decoder 230, the prototype feature generated by the last mask focal modulation stage 234 (also called a second prototype feature) may be utilized to generate the prediction mask 130. Specifically, the second prototype feature is input to a plurality of neural networks 241-242. These neural networks 241-242 are, for example, multilayer perceptron (MLP). The neural network 241 outputs the mask feature 251, and the neural network 242 outputs the category feature 252, where the size of the mask feature 251 is N×C, and the size of the category feature 252 is N×K, where K is a positive integer. Next, element-wise multiplication is performed on the mask feature 251 and the decoded feature map 221 with the maximum resolution generated by the decoder 220 to obtain a binarization mask 261, the size of binarization mask 261 is N×H×W. Then, element-wise multiplication is performed on the binarization mask 261 and the category feature 252 to obtain the prediction mask 130.

The loss function utilized in the present disclosure is shown in Formula 3:

$$ℓ = {λ}_{ce} {ℓ}_{ce} + {λ}_{dice} {ℓ}_{dice} + {λ}_{cls} {ℓ}_{cls} , \qquad [ Formula 3 ]$$

where [symbol] _{ce}, [symbol] _{dice} and [symbol] _{cls} represent binary cross-entropy loss, dice loss and classification loss, respectively, and λ_{ce}, λ_{dice} and λ_{cls} are the weights of the corresponding losses. For details, please refer to the above-mentioned second thesis.

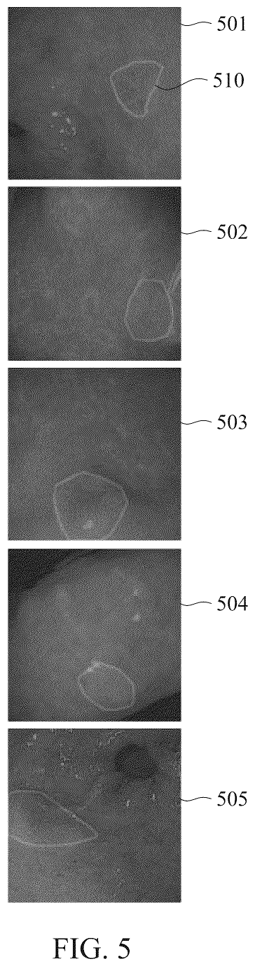

The dimension of the prediction mask 130 is H×W×K, which includes a plurality of pixels for segmenting the gastric intestinal metaplasia area. For example, the gastric intestinal metaplasia category is set to a value “1” and the background is set to a value “0”, but the present disclosure is not limited thereto. FIG. 5 is a schematic diagram of experimental results in accordance with some embodiments of the present disclosure. FIG. 5 illustrates test data 501-505, which are generated by superimposing the prediction mask 130 on the original gastric endoscopic image 110. For example, the test data 501 segments the region 510 where gastric intestinal metaplasia occurs, and so on.

In the present disclosure, a mask focal modulation network is proposed to complete the analysis of gastric endoscopic images, and may segment the region where gastric intestinal metaplasia occurs. In the network proposed in the present disclosure, due to the cooperation of the encoder and the decoder, the mask focal modulation decoder will focus on the overall features generated by different field of views, which allows the network to focus on the learnable mask, providing for better segmentation results.

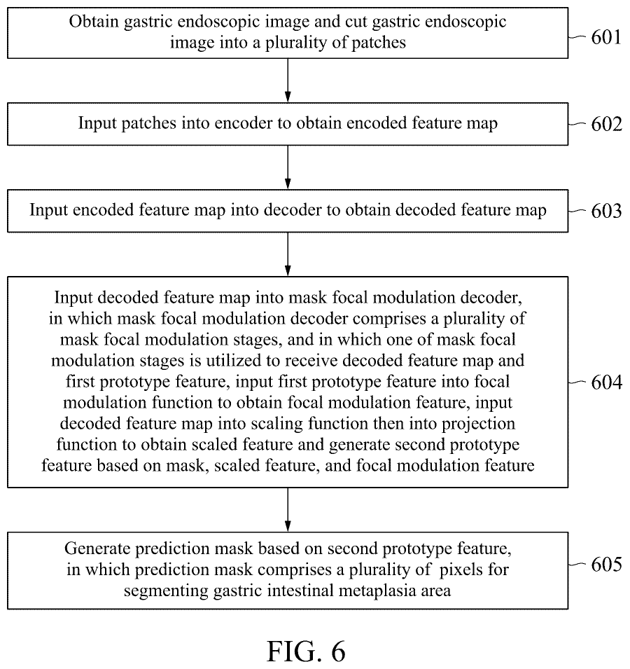

FIG. 6 is a flowchart of a method for analyzing a gastric endoscopic image utilizing image segmentation technology in accordance with some embodiments of the present disclosure. Referring to FIG. 6, in step 601, a gastric endoscopic image is obtained and cut into a plurality of patches. In step 602, the patches are input into an encoder to obtain an encoded feature map. In step 603, the encoded feature map is input into a decoder to obtain a decoded feature map. In step 604, the decoded feature map is input into a mask focal modulation decoder, in which the mask focal modulation decoder includes a plurality of mask focal modulation stages, one of the mask focal modulation stages is utilized to receive the decoded feature map and a first prototype feature, the first prototype feature is input into a focal modulation function to obtain a focal modulation feature, the decoded feature map is input into a scaling function then into a projection function to obtain a scaled feature and generating a second prototype feature based on a mask, the scaled feature, and the focal modulation feature. In step 605, a prediction mask is generated based on the second prototype feature, and the prediction mask includes a plurality of pixels for segmenting a gastric intestinal metaplasia area. Each step in FIG. 6 has been described in detail above and may not be repeated here. It should be noted that each step in FIG. 6 may be implemented as a plurality of program codes or circuits, and the present disclosure is not limited thereto. In addition, the method in FIG. 6 may be utilized in conjunction with the above embodiments or may be utilized alone. In other words, other steps may also be added between the steps in FIG. 6.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

What is claimed is:

1. An analyzing method for gastric endoscopic image utilizing image segmentation technology, the analyzing method adapted to a computer system and comprising:
obtaining a gastric endoscopic image and cutting the gastric endoscopic image into a plurality of patches;
inputting one of the patches into an encoder to obtain an encoded feature map;
inputting the encoded feature map into a decoder to obtain a decoded feature map;
inputting the decoded feature map into a mask focal modulation decoder, wherein the mask focal modulation decoder comprises a plurality of mask focal modulation stages, and wherein one of the mask focal modulation stages is utilized to receive the decoded feature map and a first prototype feature;
inputting the first prototype feature into a focal modulation function to obtain a focal modulation feature;
inputting the decoded feature map into a scaling function then into a projection function to obtain a scaled feature;
generating a second prototype feature based on a mask, the scaled feature, and the focal modulation feature; and
generating a prediction mask based on the second prototype feature, wherein the prediction mask comprises a plurality of pixels for segmenting a gastric intestinal metaplasia area.

2. The analyzing method of claim 1, wherein generating the prediction mask based on the second prototype feature comprises:
inputting the second prototype feature corresponding to a last stage among the mask focal modulation stages into a plurality of neural networks to obtain a mask feature and a category feature;
performing element-wise multiplication on the mask feature and the decoded feature map to obtain a binarization mask; and
performing element-wise multiplication on the binarization mask and the category feature to obtain the prediction mask.

3. The analyzing method of claim 1, wherein generating the second prototype feature based on the mask, the scaled feature, and the focal modulation feature comprises:
performing element-wise multiplication on the mask, the scaled feature, and the focal modulation feature to obtain the second prototype feature.

4. The analyzing method of claim 1, wherein the mask comprises a plurality of values, and the analyzing method further comprises:
determining whether each of the values of the mask is less than a threshold to generate a next stage mask.

5. The analyzing method of claim 1, wherein the decoder comprises a plurality of focal modulation blocks, and the decoder is a pixel decoder.

6. A computer system, comprising:
a memory configured to store a plurality of instructions; and
a processor coupled to the memory and configured to execute the instructions to perform the following steps:
obtaining a gastric endoscopic image and cutting the gastric endoscopic image into a plurality of patches;
inputting one of the patches into an encoder to obtain an encoded feature map;
inputting the encoded feature map into a decoder to obtain a decoded feature map;
inputting the decoded feature map into a mask focal modulation decoder, wherein the mask focal modulation decoder comprising a plurality of mask focal modulation stages, and wherein one of the mask focal modulation stages is utilized to receive the decoded feature map and a first prototype feature, inputting the first prototype feature into a focal modulation function to obtain a focal modulation feature, inputting the decoded feature map into a scaling function then into a projection function to obtain a scaled feature and generating a second prototype feature based on a mask, the scaled feature, and the focal modulation feature; and
generating a prediction mask based on the second prototype feature, wherein the prediction mask comprises a plurality of pixels for segmenting a gastric intestinal metaplasia area.

7. The computer system of claim 6, wherein generating a prediction mask based on the second prototype feature comprises:
inputting the second prototype feature corresponding to a last stage among the mask focal modulation stages into a plurality of neural networks to obtain a mask feature and a category feature;
performing element-wise multiplication on the mask feature and the decoded feature map to obtain a binarization mask; and
performing element-wise multiplication on the binarization mask and the category feature to obtain the prediction mask.

8. The computer system of claim 6, wherein generating the second prototype feature based on the mask, the scaled feature, and the focal modulation feature comprises:
performing element-wise multiplication on the mask, the scaled feature, and the focal modulation feature to obtain the second prototype feature.

9. The computer system of claim 6, wherein the mask comprises a plurality of values, and the processor is further configured to determine whether each of the values of the mask is less than a threshold to generate a next stage mask.

10. The computer system of claim 6, wherein the decoder comprises a plurality of focal modulation blocks, and the decoder is a pixel decoder.
